(19) United States
(12) Patent Application Publication
(10) Pub. No.: US 2010/0076864 A1
(43) Pub. Date: Mar. 25, 2010

(54) Systems and Methods for Integrating Debt Collection and Debtor Aid Services

(76) Inventor: Blake Reynolds, Provo, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/236,318

(22) Filed: Sep. 23, 2008

(51) Int. Cl. G06Q 30/00

(52) U.S. Cl. 705/27

(57) ABSTRACT

Improvements to debt collection services and debtor aid services are described. Embodiments of the present invention improve on current processes by integrating debtor aid services with the debt collection process. A debt collection letter process is augmented by including an insert, attachment, or other correspondence directing the debtor to a special website to assist them with their finances. If the debtor purchases one or more debt assistance products from the website, the collection agency is provided with a commission, thereby improving the collection agency's profits. As the debtor learns to better manage his or her finances, the debtor benefits from increased financial freedom and increased ability to pay outstanding debts, which returns to benefit the collection agency's efforts and the creditor's recovery.

### BACKGROUND OF THE INVENTION

1. Field of the Invention

The present invention relates to debt collection services, and more particularly to integrating debt collection services with marketing of debtor aid services.

2. Background and Related Art

Current debt collection practices are fairly limited. For example, FIG. 3 provides a flow chart illustrating current practices. According to current practices, execution begins at step 100 where a collection agency receives placement of a debt for collection from a creditor who is or becomes a client of the debt collection agency. The debt may be a debt owed to the creditor by a consumer. When the consumer fails to pay the debt per the previously agreed-upon terms, the creditor opts to enlist the assistance of the collection agency. The creditor and the collection agency agree to terms under which the collection agency will seek to collect the debt, and the terms may include fixed fee terms (which may be paid by the creditor immediately or at a later time) or contingent fee terms (with a percentage of the recovered debt being paid to the collection agency). The agreement may include different levels of remuneration for the collection agency depending on the efforts required to collect on the debt.

At step 104, the collection agency typically begins the debt collection process by sending one or more collection letters to the debtor, seeking payment on the outstanding debt. At decision block 112, a determination is made as to whether the debt has been resolved, such as by full or agreed-upon partial payment. If the debt has been resolved, execution proceeds to step 118, where the creditor receives the creditor's portion of the recovered money, and the collection agency receives its portion as payment for the debt collection efforts. Of course, the collection agency may have been paid some or all of its fee up front, so in such instances the creditor receives all recovered funds at step 118, whereupon, the process is complete.

In some instances, the debt has not been resolved after one or a series of debt collection letters by the agency, execution may proceed to step 122, where the collection agency takes further action to collect the debt, which may include legal and/or other actions, including suits, garnishment of wages, etc. At decision block 126, it is determined if settlement has been received. If yes, execution proceeds to step 130 where the settlement is distributed to the collection agency and the creditor, such as in the manner originally agreed-upon, whereupon execution ends. If settlement has not been received after further efforts by the collection agency, the process may end, such as by the debt being written off as uncollectable or being sold to another entity.

This process presents a conflict for the collection agency, and presents only limited opportunities for the collection agency to benefit. If the debtor pays the debt early in the process, the collection agency's costs are low, and the collection agency's recovery is also fairly limited, although the creditor is typically pleased with the recovery. If the debtor pays after many collection letters, the costs are higher for the collection agency, and the collection agency's recovery is typically further limited, while the creditor is still pleased. In contrast, if the debtor fails to settle the debt until significant efforts have been expended by the collection agency, the collection agency will potentially receive additional revenue. However, the collection agency's costs are high in such instances and even with receipt of a larger portion of the recovered debt the collection agency's recovery is fairly limited. In such instances, the creditor is less pleased with a reduced and delayed collection.

Thus, currently-existing methods fail to ensure maximum compensation for the creditor and/or the collection agency. The current methods also fail to minimize conflicts between the collection agencies and the creditors, as collection agencies' profits increase and creditors' recovery decreases the longer it takes to collect on debts.

### BRIEF SUMMARY OF THE INVENTION

Implementation of the present invention provides integration between debt collection services and debtor aid services. Additional revenue streams are provided to the debt collections process, the debtors are assisted to improve their finances, and debts are more quickly collected. Because debts are more quickly collected, creditors benefit from increased recoveries and lesser costs paid to the collection agencies. Collection agencies benefit from the additional revenue streams, reducing the conflict presented by the increased revenues received from delayed payment by the debtors. The debtors are assisted to better understand their finances and are assisted to improve their progress toward financial freedom.

Implementation of the present invention improves on current processes by integrating debtor aid services with the debt collection process. The debt collection process according to implementation of the present invention is similar to current processes, but the debt collection letter process is augmented by an insert, attachment, or other correspondence directing the debtor to a special website to assist the debtor with his or her finances. The website provides debt assistance services, and may provide a free trial of the services to the debtor. If the debtor purchases one or more debt assistance products from the website, the collection agency is provided with a commission, thereby improving the collection agency's profits. As the debtor learns to better manage his or her finances, the debtor benefits from increased financial freedom and increased ability to pay outstanding debts, which returns to benefit the collection agency's efforts and the creditor's recovery.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system for use with embodiments of the present invention;

FIG. 2 shows a representative network of computer systems for use with embodiments of the present invention;

FIG. 3 shows a flow chart for a prior art process for collecting debts;

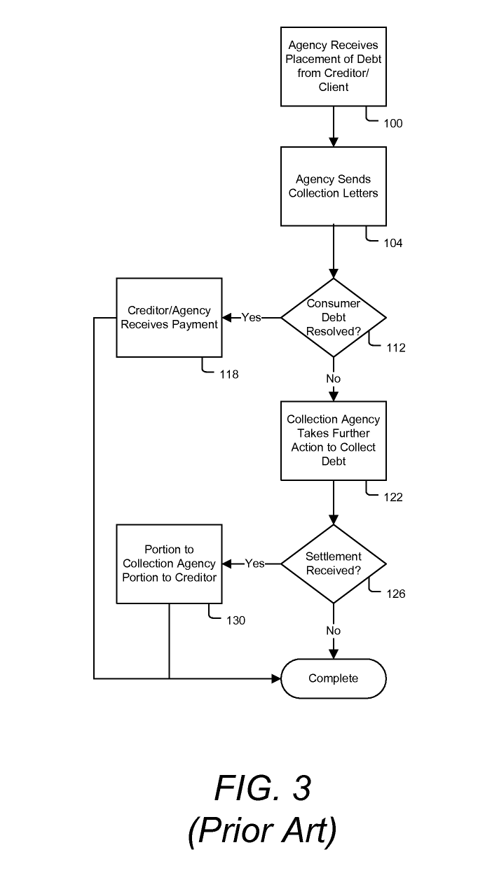

FIG. 4 shows a flow chart for an improved process for collecting debts;

FIG. 5 shows a flow chart illustrating in more detail features of the process of FIG. 4; and

FIG. 6 shows a flow chart illustrating in more detail features of the process of FIG. 5.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the present invention provide integration between debt collection services and debtor aid services. Additional revenue streams are provided to the debt collections process, the debtors are assisted to improve their finances, and debts are more quickly collected. Because debts are more quickly collected, creditors benefit from increased recoveries and lesser costs paid to the collection agencies. Collection agencies benefit from the additional revenue streams, reducing the conflict presented by the increased revenues received from delayed payment by the debtors. The debtors are assisted to better understand their finances and are assisted to improve their progress toward financial freedom.

Embodiments of the present invention improve on current processes by integrating debtor aid services with the debt collection process. The debt collection process according to embodiments of the present invention is similar to current processes, but the debt collection letter process is augmented by an insert, attachment, or other correspondence directing the debtor to a special website to assist with his or her finances. The website provides debt assistance services, and may provide a free trial of the services to the debtor. If the debtor purchases one or more debt assistance products from the website, the collection agency is provided with a commission, thereby improving the collection agency's profits. As the debtor learns to better manage his or her finances, the debtor benefits from increased financial freedom and increased ability to pay outstanding debts, which returns to benefit the collection agency's efforts and the creditor's recovery.

As is commonly known, information has, of late, become increasingly valuable for various types of business seeking to reach out and attract customers. Information is particularly valuable when it is allows businesses to target persons who may be most interested in the goods or services offered by a particular business. Thus, the information in the possession of creditors and collection agencies regarding the identity of debtors is potentially very valuable to businesses seeking to provide services to debtors. However, it has been difficult or impossible for creditors or collection agencies to leverage this information.

The Fair Debt and Collection Practices Act (“FDCPA”) strictly limits the actions that may be taken by collection agencies and others attempting to collect debts. The limitations imposed by the FDCPA generally prohibit contact with third parties regarding debtors and their debts, preventing creditors and collection agencies from disclosing the names or other identifying information regarding the debtors to other parties, even parties that could assist the debtors to pay off existing debts and achieve financial independence. Embodiments of the invention provide systems and methods that legally leverage the information possessed by creditors and collection agencies to generate additional revenue streams while connecting debtors with service providers seeking to aid the debtors with their finances. These systems and methods do not violate the FDCPA, and serve to improve the experience of all parties involved in the debt collections process.

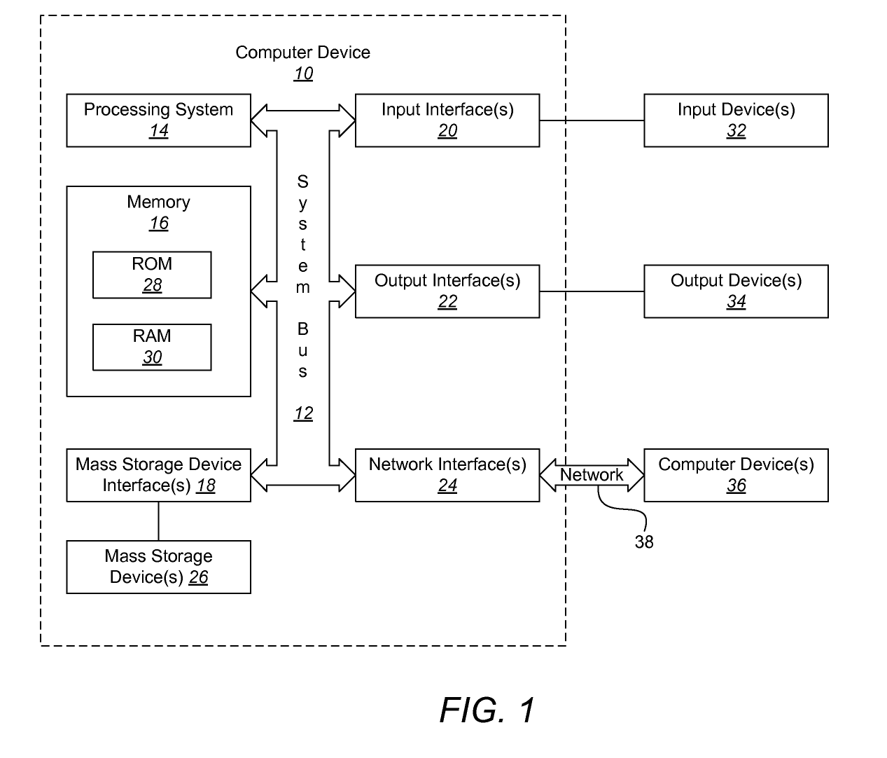

As at least some embodiments of the invention utilize computer systems and networks of computer systems, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing embodiments of the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

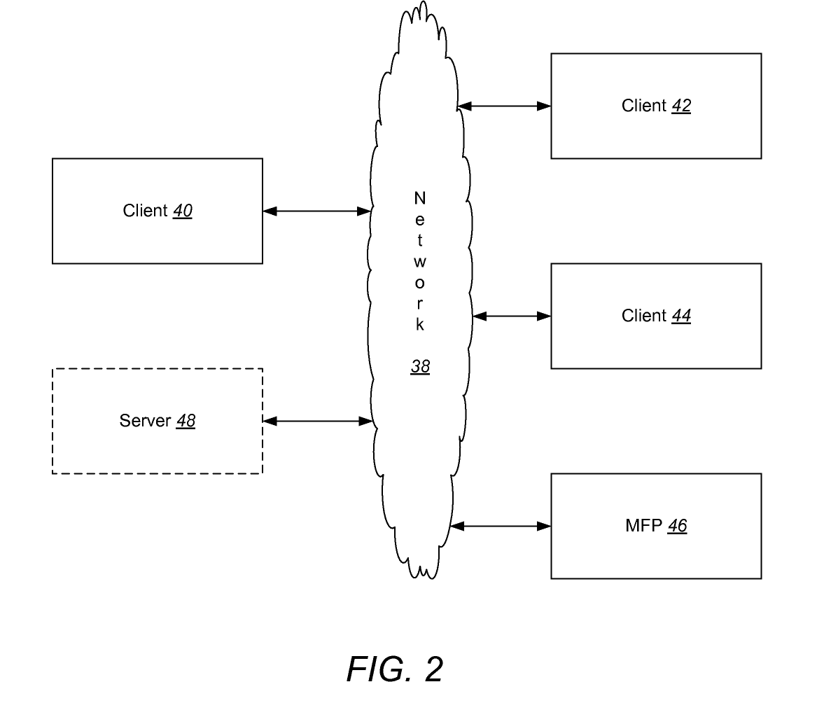

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

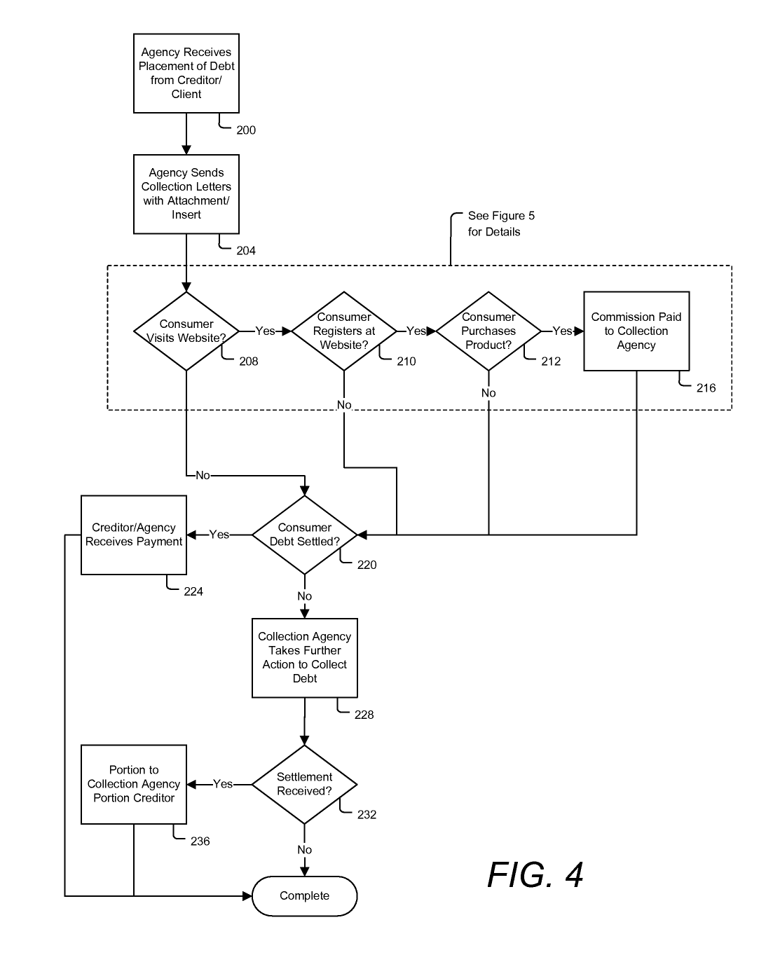

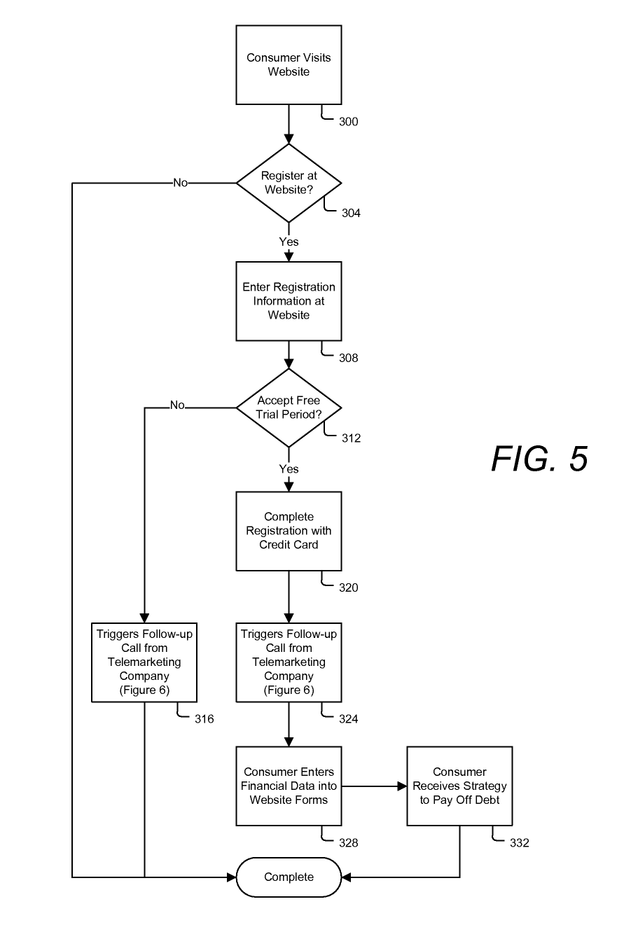

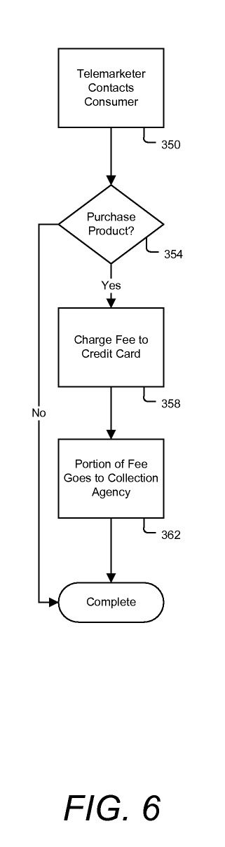

By way of example, FIGS. 4-6 illustrate flow charts depicting systems and methods in accordance with embodiments of the present invention. FIG. 4 presents a general overview of one embodiment of a process according to the present invention, and FIGS. 5 and 6 illustrate more detailed views of processes that may be used according to FIG. 4. In FIG. 4, execution begins at step 200, where a collection agency receives placement of a debt for collection from a creditor/client. The debt may represent a consumer obligation from a debtor to the creditor, that has not been paid as per the terms of the original debt agreement. The creditor either pays the collection agency or agrees to pay the collection agency to collect the debt; the payment to the collection agency may be a fixed amount or may be a percentage of the total debt or of the debt finally collected by the collection agency. The agency agrees to send a series of letters requesting payment of the debt.

Execution then proceeds to step 204, where the collection agency sends collection letters to the debtor requesting payment of the debt, similarly to what currently occurs in debt collection practices. In addition to the debt collection letters, the collection agency includes an attachment, insert or other information directing the debtor/consumer (“debtor’) to a special website that offers to provide assistance with the debtor's finances. The attachment, insert, or other information directing the debtor to the special website does not violate the FDCPA, as no information about the debtor is provided to any third party: the attachment, insert or other information directing the debtor to the special website is provided directly to the debtor with the debt collection letters without passing any information about the debtor to third parties.

The special website is provided by a party providing debtor aid and other financial services to consumers, such as a party providing financial counseling and debt elimination plans to financially-burdened consumers. The special website may be a website dedicated to serving debtors who have been contacted by a particular collection agency, or it may be a general website serving a larger clientele, wherein persons directed to the special website by the attachment, insert, or other information included in the debt collection letters by the collection agency identify that they were directed to the website by the collection agency, such as by inputting a code included in the attachment, insert, or other information. Where such a code is utilized, it is a code that merely identifies the collection agency to the website; no information about the debtor or the debtor's debt is provided to the party providing debtor aid and other financial services that runs the website.

The debtor is free to visit the special website or not; the debtor is free to pay the debt in response to the collection letter(s) without ever visiting the special website. In such instances, the process proceeds without the illustrated steps regarding the debtor's visit to the special website. The collection letters and/or the attachment, insert, or other information may make this point clear to the debtor, such as by a disclaimer provided on the attachment, insert, or other information. The collection agency may also send CDs or other media regarding the services provided by the special website and/or the provider of the special website, thereby providing more information to the debtor regarding those services.

Therefore, after the collection agency sends the letter or letters, execution proceeds to decision block 208, where a determination is made of whether the debtor visited the special website. If not, execution proceeds to step 220, where a determination is made as to whether the debt has been settled. The debt may be settled by full or agreed-upon partial payment. If the debt has been resolved, execution proceeds to step 224, where the creditor receives the creditor's portion of the recovered money, and the collection agency receives its portion as payment for the debt collection efforts. Of course, the collection agency may have been paid some or all of its fee up front, so in such instances the creditor receives all recovered funds at step 224, whereupon, the process is complete.

In some instances, the debt has not been resolved after one or a series of debt collection letters by the agency, execution may proceed to step 228, where the collection agency takes further action to collect the debt, which may include legal and/or other actions, including suits, garnishment of wages, etc. At decision block 232, it is determined if settlement has been received as a result of the further action to collect the debt. If yes, execution proceeds to step 236 where the settlement is distributed to the collection agency and the creditor, such as in the manner originally agreed-upon, whereupon execution ends. If settlement has not been received after further efforts by the collection agency (and it determined to take no further action), the process may end, such as by the debt being written off as uncollectable or being sold to another entity.

Thus, the processes utilized by the collection agency are derivative to those currently used, whereby implementation of the embodiments of the current invention will be straightforward to collection agencies. The collection agencies are only minimally involved in the additional steps taken when the debtor visits the special website, as determined at decision block 208, so the primary additional action taken by the collection agencies is the inclusion of the attachment, insert, or other information in the debt collection letters sent by the collection agency. If it is determined at decision block 208 that the debtor has visited the special website, execution proceeds to decision block 210, where a determination is made as to whether the consumer has registered at the website. If the consumer visits the website but fails to register, execution proceeds to decision block 220 and the process continues as discussed above.

If, however, the debtor has registered at the website, execution proceeds to decision block 212, where a determination is made as to whether the debtor has purchased a product through the website. If not, execution proceeds to decision block 220 and the process continues as discussed above. If, however, the debtor purchases a product, execution proceeds to step 216, where a commission is paid to the collection agency, thereby generating an additional revenue stream for the collection agency. Simultaneously, the debtor benefits from the financial services provided by the owner of the website. The debtor becomes better able to meet his or her financial obligations, resulting in increased payments to the collection agency, with increased recovery to the creditor and the collection agency, thereby benefiting all parties.

FIG. 5 illustrates in more detail one embodiment of processes that may occur when the debtor visits the special website referenced in the letter from the collection agency. At step 300, the debtor visits the website, whereupon execution proceeds to step 304, where a determination is made as to whether the debtor registers at the special website. Registration at the website may be based on a time-bounded offer with a special code that may be included in the attachment, insert, or other information sent by the collection agency with the collection letter or letters. The offer may also include a free trial period of the services provided by the website owner.

As the process is entirely voluntary on the part of the debtor, if the debtor chooses not to register at the special website, execution ends (and the debt collection agency processes may continue as normal). In contrast, if the debtor registers at the website at step 308, such as by entering contact information, a new relationship is formed between the website owner and the debtor, whereby the website owner is now able to contact the debtor directly—not about the debt, but about the debtor's potential business as a client of the website owner to obtain the services provided by the website owner.

The website owner may offer a free trial period of the services provided by the website owner. In some instances, the free trial period may be contingent on the debtor providing valid credit card information for future billing after termination of the free trial period. If a free trial is offered, a determination is made at decision block 312 whether the debtor has accepted the free trial period offer. If not, execution proceeds to step 316, where the failure to accept the free trial period triggers a follow-up call from a telemarketing company using the registration information provided upon registration at the special website. FIG. 6 provides a flowchart illustrating details of one embodiment of a telemarketer contact made to the debtor.

At step 350, a telemarketer contacts the debtor, who is now a potential consumer of the services provided by the website owner. The telemarketer explains benefits of the product/services offered, and encourages the potential consumer to purchase the product/services. Thereafter, execution proceeds to decision block 354, where a determination is made as to whether the potential consumer wishes to purchase the product/services. If not, execution ends. If so, execution proceeds to step 358, where the purchase price is charged to the consumer's credit card. Alternatively, the consumer's valid credit card information is obtained, and a free trial begins, whereupon upon termination of the free trial, the purchase price is charged. When the product/services is purchased, execution proceeds to step 362, where a portion of the fee is provided to the collection agency as a commission. Thereupon, execution is complete.

Returning to FIG. 5, if the debtor accepts the free trial period, execution proceeds to step 320, where the debtor is prompted to provide valid credit card information to register for the free trial period. This information is saved for billing purposes once the free trial has ended. Execution then proceeds to step 324, where registration triggers a follow-up call from a telemarketer, as discussed above with respect to FIG. 6. In this instance, however, the call from the telemarketer may occur after the end of the free trial period or near the end of the free trial period to encourage purchase of the product/services. Alternatively, the call from the telemarketer may be to encourage purchase of additional products/services. In some instances, this step may be skipped where it is determined that a telemarketer contact is not needed. It should be understood that a call from a telemarketer may be augmented or replaced with other directed marketing techniques, including mailers and/or e-mails.

Execution then proceeds to step 328, where the debtor enters financial data into various website forms as part of the services offered by the special website. Upon entry of the relevant data, execution proceeds to step 332, where the debtor receives one or more financial services/strategies designed to improve the debtor's financial situation, including one or more strategies to pay off the debt that triggered the original debt collection actions. It should be noted that this information is provided to the debtor entirely based on information provided to the website from the debtor, and not based on any information provided by the collection agency, as the collection agency provides no information to the special website regarding the debtor.

Enhanced systems and processes in accordance with or similar to the specific embodiments discussed above provide benefits to all parties when the debtor elects to utilize the product/services of the special website. The creditor benefits in that the debtor is more likely to settle the debt and more likely to do so in a timely fashion. Therefore, the creditor gets more money more quickly. The collection agency benefits from the creditor's increased satisfaction with the collection agency's efforts. Additionally, the collection agency benefits from additional revenue streams from the commission received when the debtor purchases the services/products. In some embodiments, the revenue stream is a one-time stream provided at the time of purchase, and in other embodiments, the revenue stream is an ongoing stream, such as one that continues as long as the debtor/consumer continues subscribing to the service (e.g. as long as the debtor pays a monthly fee, the collection agency is paid a monthly commission). If the revenue stream is an ongoing stream, it may continue indefinitely or be limited in time to a certain time the debtor subscribes to the services/products. The special website provider benefits from additional customers and potential customers who are in particular need of the services/products provided at the special website (i.e. targeted advertising). Finally, the debtor benefits by having a better understanding of his or her finances, by having a better capability to pay off outstanding debts, and by being assisted onto a path of increased financial freedom.

The above-described embodiments are intended to be illustrative and not limiting. Other embodiments may be provided and fall within the scope of the claimed invention. For example, while the collection agency provides no information regarding the debtors to the provider of the special website or to other third parties, the collection agency may receive back information from the provider of the special website with the commissions that may be used by the collection agency in various ways. For example, the collection agency may initially provide the attachment, insert, or other information with all its collection letters, with each mailing receiving its own identifying code to be entered into the special website by the debtor. A portion of the identifying code may identify the collection agency to the website provider, or alternatively, the special website is dedicated solely to persons contacted by the collection agency, as discussed above. The remainder of the code means nothing to the website provider, but is transmitted with the commission and/or upon registration at the website to the collection agency. The collection agency can use this information to improve targeting of the attachment, insert, or other information either to a class of debtors more likely to utilize the services or to a point in time in the collections process where it will be most effective. At no time is information about the debtor sent by the collection agency to any third party in this process.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for integrating debt collection and debtor aid services comprising:
receiving placement of a debt from a creditor at a collection agency;
sending a collection letter to a debtor owing the debt, the collection letter including an attachment, insert, or other information directing the debtor to a website offering one or more debtor aid services; and
receiving a commission at the collection agency from a provider of the website when the debtor makes a purchase through the website.

2. A method as recited in claim 1, wherein the purchase through the website comprises a purchase of a debtor aid service.

3. A method as recited in claim 2, wherein the debtor aid service comprises a service to provide a strategy for the debtor to pay off the debt.

4. A method as recited in claim 1, wherein the website is one specifically associated with the collection agency, whereby all purchases of products at the website result in commissions to the collection agency.

5. A method as recited in claim 1, wherein the attachment, insert, or other information comprises a code to be entered at the website by the debtor, thereby identifying the collection agency to the website provider for payment of the commission to the collection agency.

6. A method as recited in claim 1, further comprising:
determining that the debtor visits the website; and
determining that the debtor registers at the website, wherein when the debtor registers at the website, contact information for the debtor is obtained by the website provider.

7. A method as recited in claim 7, further comprising initiating a marketing contact with the debtor presenting information regarding and an opportunity to purchase a service or product offered by the website provider.

8. A method as recited in claim 7, further comprising offering a free trial period for a service or product offered by the website provider.

9. A method as recited in claim 7, further comprising:
receiving financial information from the debtor; and
providing the debtor with a strategy to pay off the debt.

10. A method as recited in claim 1, further comprising:
providing a unique identifier with the attachment, insert, or other information to be used by the debtor upon accessing the website; and
receiving a portion of the unique identifier at the collection agency and from the website provider with the commission.

11. A method as recited in claim 1, further comprising sending additional collection letters to the debtor that include additional attachments, inserts, or other information directing the debtor to the website.

12. A method for utilizing information of a collection agency to market debtor aid services to debtors comprising:
receiving, at a collection agency, information regarding a debt owed by a debtor to a creditor;
generating a communication to the debtor requesting payment of the debt, wherein the communication to the debtor includes one of:
an attachment directing the debtor to a website offering one or more debtor aid services or products;
an insert directing the debtor to a website offering one or more debtor aid services or products; and
other information directing the debtor to a website offering one or more debtor aid services or products; and
receiving, at the collection agency, a commission from a provider of the website when the debtor makes a purchase from the provider of the website.

13. A method as recited in claim 12, wherein the attachment, insert, or other information comprises a code to be entered at the website by the debtor, thereby identifying the collection agency to the website provider for payment of the commission to the collection agency.

14. A method as recited in claim 12, further comprising:
determining that the debtor visits the website; and
determining that the debtor registers at the website, wherein when the debtor registers at the website, contact information for the debtor is obtained by the website provider.

15. A method as recited in claim 14, further comprising initiating a marketing contact with the debtor presenting information regarding and an opportunity to purchase a service or product offered by the website provider.

16. A method as recited in claim 14, further comprising:
receiving financial information from the debtor; and
providing the debtor with a strategy to pay off the debt.

17. A method as recited in claim 12, further comprising:
providing a unique identifier with the attachment, insert, or other information to be used by the debtor upon accessing the website; and
receiving a portion of the unique identifier at the collection agency and from the website provider with the commission.

18. A method for utilizing information of a collection agency to integrate delivery of debtor aid services to debtors with the collection of outstanding debts comprising:
receiving, at a collection agency and from creditors, information regarding debts owed by debtors to the creditor and subject to collection;
generating a plurality of letters to the debtors requesting payment of the debt, wherein the letters to the debtors includes one of:
an attachment directing the debtors to a website offering one or more debtor aid services or products;
an insert directing the debtors to a website offering one or more debtor aid services or products; and
other information directing the debtors to a website offering one or more debtor aid services or products; and
receiving, at the collection agency, a commission from a provider of the website when each debtor makes a purchase from the provider of the website.

19. A method as recited in claim 18, further comprising:
providing a unique identifier with each attachment, insert, or other information to be used by each debtor upon accessing the website; and
receiving a portion of the unique identifier at the collection agency and from the website provider with the commission.

20. A method as recited in claim 19, further comprising using the received portions of the unique identifiers to determine when and with whom the attachments, inserts, or other information was successful in prompting purchases at the website.
